(19) United States
(12) Patent Application Publication
(10) Pub. No.: US 2020/0237619 A1
(43) Pub. Date: Jul. 30, 2020

(54) BAG FOR PROVIDING PATIENT-SPECIFIC DRUGS

(71) Applicant: EUROZYTO GMBH, Königstein (DE)

(72) Inventor: Uwe-Bernd Rose, Königstein (DE)

(21) Appl. No.: 16/486,398

(22) PCT Filed: Feb. 15, 2018
(86) PCT No.: PCT/DE2018/200011

§ 371 Date: Aug. 15, 2019

(30) Foreign Application Priority Data
Feb. 6, 2017 (DE) 102017202510.7

(51) Int. Cl. A61J 1/10; A61J 1/14; A61J 1/20

(52) U.S. Cl. CPC A61J 1/10; A61J 1/2093; A61J 1/1475

(57) ABSTRACT

Bag for providing patient-specific, in particular oncological drugs, with an interior divided into a plurality of, preferably four, separate chambers interior, wherein in at least one, preferably three chambers an infusion solution can be provided and patient-specific active substances can be added.

The present invention relates to a bag for providing patient-specific, in particular oncology drugs.

In practice, in medical, especially in oncological applications, several separate bags filled with infusion solution, so-called prefill bags, are used. Before the delivery of a patient-specific active substance, such as, for example, cytostatics, first of all liquid is withdrawn from it, namely according to the volume of the active substance to be administered. After removal of the appropriate volume of infusion solution, the bags are refilled in a second step with the appropriate drug. Both the removal of the infusion solution and the delivery of the active substance should be carried out in a GMP-regulated (good-manufacturing-practice-regulated) clean room due to the existing risk of contamination. The respective country-specific laws and regulations contain stipulations for this. Each step is done with the utmost accuracy and is logged. Accordingly, therefore, several steps in the clean room are required. This is time-consuming, space-intensive and costly.

A high risk of contamination arises not only when preparing the bag, i.e. when emptying and filling it with active ingredient, but also when connecting and re-attaching the individual bags directly to the patient. This results in a fairly high risk of infection. In addition, the transfer of infusion solutions to patients causes further problems, such as blood leakage at the venous connection of the patient.

A further disadvantage of the standard known from practice lies in the complicated disposal of the individual bags and the necessary protective equipment for handling.

In addition to the bags providing an infusion solution with active substance, there are other, separate bags, namely for providing a rinsing solution or other drugs for pre- or post-medication, which make the handling more complicated and further increase the disposal and the risk of contamination.

Furthermore, when using individual bags, there is a risk of likelihood, not to be neglected, of mixing up the bags and thus the patient-specific active substances, in particular in the sequence of administration.

The required technical measures must relate to the design of the bag used to provide the infusion solution.

The present invention is therefore based on the object to offer a way to provide and administer patient-specific, especially oncological drugs safely and inexpensively with simple design.

The above object is achieved by the features of claim 1. Accordingly, the bag for providing patient-specific, in particular oncology drugs, has an interior divided into a plurality of, preferably four, separate chambers, wherein at least one, preferably three chambers provide a solution for infusion and to which patient-specific active substances can be added.

In the present invention, it was recognized that it is not necessary to use several separate bags that need to be partially emptied and refilled with the drug in an extremely complicated manner in a sterile environment and then merged for administration at the risk of mix-up and contamination. On the contrary, the invention goes a completely different way, namely, not just several separate bags are used, but rather the interior of one bag is divided into separate chambers. Specifically, the bag has an interior divided into a plurality of, preferably four, separate chambers, wherein an infusion solution can be provided or is provided in at least one, preferably three chambers and patient-specific active substances can be added. Also, more than 3 chambers with infusion solution for the addition of active substances is conceivable. This not only eliminates working steps in the clean room, but simplifies overall handling, reducing the risk of contamination and infection during handling, resulting waste, required working area and production time. The likelihood of a mix-up is counteracted by the exclusive use of a single bag.

Consequently, with the bag according to the invention for the provision of patient-specific, in particular oncological drugs, a possibility is indicated to provide and administer patient-specific, in particular oncological drugs safely and inexpensively with a simple design.

Advantageously, at least one, preferably exactly one, of the chambers serves to provide a rinsing solution. This saves the user attaching a separate bag with the appropriate rinse solution and an additional connection with the other bags. This rinsing solution also serves to avoid the mixing of residues of the infusion solutions, which in extreme cases could lead to undesirable interactions in the active substances. Conceivable are NaCl, Ringer or glucose solutions.

It is particularly advantageous if the interior of the bag has exactly four chambers, three of which serve to provide a solution and for the addition of a patient-specific active substance and the fourth chamber to provide a rinsing solution.

Furthermore, the formation of the bag from a tube is suitable for simple and cost-effective production. In this case, preferably polymer-based wide tubes, in particular polyolefins (POF), in particular polyethylene (PE) and/or polypropylene (PP), polyvinyl chloride (PVC) and/or ethylene vinyl acetate (EVA) are suitable. Polypropylene (PP) and polyethylene (PE) are characterized in the use for the bags according to the invention in particular by their high stability. Other advantages include transparency, low density compared to other materials, low water absorption, excellent chemical resistance to chemicals and physiological safety. In addition, polypropylene (PP) is particularly corrosion resistant. Polyethylene (PE) has anti-adhesive properties and is also suitable for use at low temperatures. Particularly advantageous for polyvinyl chloride (PVC) is its high chemical resistance, ease of processing, good weather resistance, low moisture absorption and transparency. For example, the tubes can be welded together at the edge of the tube by induced heat. The chambers are advantageously formed by welds, in particular by means of induced heat and/or by gluing and/or by clamping means, in particular clamps. By clamping means, the number of individual chambers is variable.

In a further advantageous manner, the chambers are multi-layered, wherein the individual layers may consist of the same or different materials. By a multi-layered design, the gas density of the bag or the system can be increased.

Furthermore, it is advantageous if the chambers are at least partially dimensioned differently in their volume, depending on the volume requirement of the corresponding application. Equally large chambers are also conceivable. Preferred volumes of the individual chambers are 500 ml, 250 ml and 100 ml.

For filling and/or emptying the chambers with infusion solution and/or with active substance, it is of particular advantage if each chamber is assigned at least one connection piece. This can be a tube inlet for filling a chamber and a tube outlet for emptying a chamber or a connecting piece which simultaneously serves as tube inlet and tube outlet. In particular at the tube outlet, a Luer-Lock tube connector is suitable.

It is particularly advantageous to place a merging system on the bag. Specifically, the merging system may comprise a plurality of tubes connected at one end to a chamber or connection piece of the chambers, respectively, and converging at the other end for administration to the patient in preferably one tube. A transfer of the merging system to the patient and a multi-tap system are thereby eliminated. The contents of the individual chambers may be administered one by one or simultaneously to the patient, preferably with the fluids of the individual chambers being sequentially administered without mixing.

The merging system can be arranged in a further advantageous manner, one or more injection ports for the addition of other liquids and/or active substances. These are particularly well suited for further injections during treatment.

It is particularly advantageous to control or regulate the inflow from the filled bag chambers via closing clips on the tubes of the merging system. This is particularly advantageous in order to avoid a mixing of the liquids or active substances and to administer them to the patient one after the other.

Advantageously, the entire bag, the connection piece and/or the merger system is made exclusively on polymer basis and has/have no metal parts. In particular, polyolefins (POF), in particular polyethylene (PE) and/or polypropylene (PP), polyvinyl chloride (PVC) and/or ethylene-vinyl acetate (EVA) are particularly well suited for the bag. The foregoing benefits of these materials apply accordingly.

In order to realize an almost complete emptying of the chambers, it is of particular advantage to design the chamber shape and/or the materials used and/or the surface structuring of the interior of the bag accordingly, so that the patient can be administered his complete, individual dose.

To protect the active substances from light, it is of particular advantage if the chambers and/or the at least one connecting piece and/or the merging system is made of colored plastic which has a photoprotective effect. Alternatively, it is conceivable to produce the chambers and/or the at least one connecting piece and/or the merging system from a clear plastic without light protection and to additionally surround this/these with a photoprotective shell.

The object mentioned above is also achieved by a set having the features of claim 14. It is of particular importance for the set according to the invention for providing patient-specific, particularly oncological drugs that it comprises a bag according to the invention and a merging system which is couplable with the bag for administering the patient-specific, in particular oncological drugs to a patient. The bag and the merging system can be accommodated together in a closed package. The set preferably consists of a bag and a merging system, which are each received individually, i.e. separately from each other, in a sealed package. This set allows the immediate application of the patient-specific, in particular oncological drugs, whereby bag and merging system are contained in the packaging(s). It is advantageous if the bag and merging system are included sterile in the packaging(s). For this purpose, the packaging(s) may consist of a foil which allows for sterilization of the bag and the merging system. For an immediate applicability of the set, it is conceivable if at least the infusion solution and possibly the rinsing solution are already contained in the bag, so that only active substances must be added.

Furthermore, it should be noted at this point that the bag according to the invention can provide different drugs, in particular cytostatics, which are based on different mechanisms of action. In this case, chemical substances can be provided individually or as a regimen in a bag. Conceivable cytostatics—substance groups are vinca-alkloids such as vinblastine, vincristine or vinorelbine, epipodophyllotoxins such as etoposide, teniposide, camptothecins such as topotecan or irinotecan, antibiotic substances such as anthracyclines, antimetabolites such as modified purine and pyrimidine bases e.g. flurouracil or gemcitabine, alkylating agents such as bisulfane or cyclophosphamide, platinum substances such as carboplatin or oxaliplatin, enzymes such as asparaginase, hormones such as corticosteroids, monoclonal antibodies such as atemtzuzumab or rituximab, taxanes such as paclitaxel, topoisomerase inhibitors such as etoposide, irinotecan or topotecan, intercalants containing, for example, anthracyclines, doxorubicin (Adriamycin), daunorubicin, epirubicin, idarubicin, mitoxantrone or amsacrine, aromatase inhibitors such as nastrozole, exemestane or letrozole, amatoxins, mitotane, hydroxycarbamide, altretamine, mitotic inhibitors such as vinorelbine, vincristine (Oncovin), vinblastine or vindesine, intercalants such as anthracyclines, doxorubicin (Adriamycin), daunorubicin, epirubicin, idarubicin, mitoxantrone or amsacrine, enzyme inhibitors such as tyrosine kinase inhibitors. As a supplement, antiemetics and/or analgesics can be provided in the bag.

Independent of oncological drugs, patient-specific drugs are also conceivable for enzyme replacement therapy. For example, for the treatment of patients with Fabry disease, the bag can provide, among other things, agalsidase alpha and agalsidase beta, for the treatment of Morquio's disease elosulfase alfa, for the treatment of Pompe disease alglucosidase alfa, or for the treatment of paroxysmal nocturnal hemoglobinuria eculizumab, which are administered as intravenous infusions.

There are now various possibilities for designing and developing the teaching of the present invention in an advantageous manner. For this purpose, reference is made on the one hand to the claims subordinate to claim 1 and on the other hand to the following explanation of preferred embodiments of the invention using the drawings. In conjunction with the explanation of the preferred exemplary embodiments of the invention with reference to the drawings, generally preferred embodiments and developments of the teaching are also explained. In the drawings,

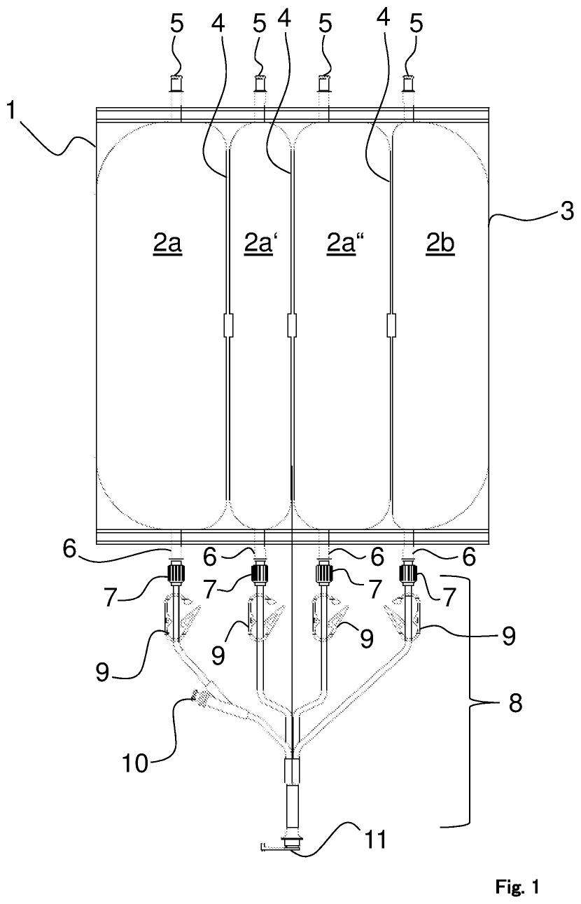

FIG. 1 shows a schematic view of a first exemplary embodiment of a bag 1 according to the invention for providing patient-specific, in particular oncological drugs, and

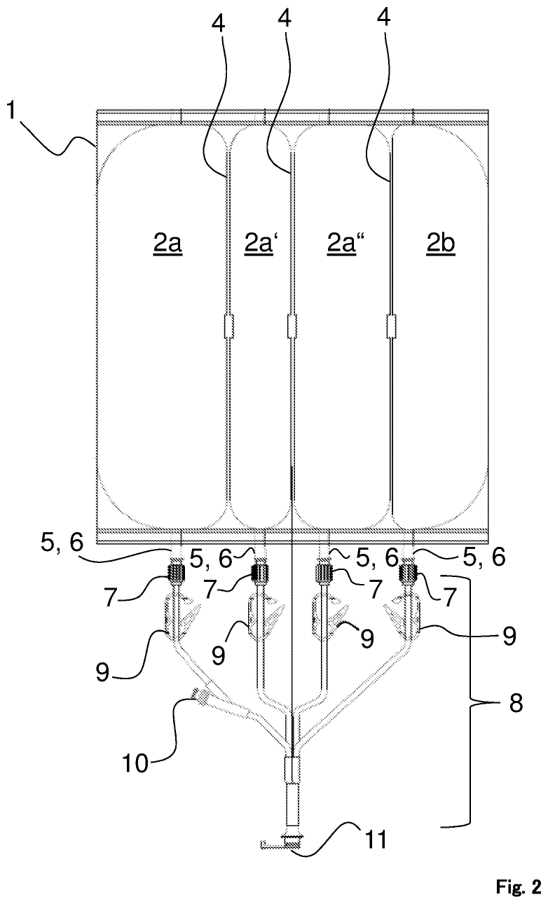

FIG. 2 shows a schematic view of a second exemplary embodiment of a bag 1 according to the invention for providing patient-specific, in particular oncological drugs.

FIG. 1 shows a bag 1 for providing patient-specific oncological drugs, which has in its interior four separate chambers 2a, 2a′, 2a″, 2b, wherein three of the chambers 2a, 2a′, 2a″ for providing an infusion solution and adding a patient-specific active substance and the fourth chamber 2b serve to provide a rinse solution. The bag 1 is made of a wide ethylene-vinyl acetate (EVA) tube, wherein a weld 3 forms the right bag wall. The inner walls 4 of the individual chambers 2a, 2a′, 2a″, 2b are welded together by induced heat. The chambers 2a, 2a′, 2a″, 2b have partially different volumes, specifically 500 ml, 100 ml and twice 250 ml. Furthermore, the chambers 2a, 2a′, 2a″, 2b are elongated and have on their upper side a tube inlet 5 for filling the chambers 2a, 2a′, 2a″, 2b and at their lower side a tube outlet 6 for emptying the chamber 2a, 2a′, 2a″, 2b. The active substances are added through the tube inlet 5 into the respective chamber 2a, 2a′, 2a″, 2b.

The tube outlet 6 is associated with a Luer-Lock tube connector 7, by means of which the bag 1 is connected to a merging system 8. The merging system 8 comprises individual tubes, each connected to a tube outlet 6, which are brought together on the ends opposite the tube outlets 6. In the region of the Luer-Lock tube connector 7, closing clips 9 made of plastic are arranged to regulate the flow. The leftmost outermost tube of the merging system 8 is assigned an injection port 10 for further injections during the treatment. At the end of the merging system 8 opposite the bag 1, an opening 11 or a port for administering the drug via an infusion line to the patient is provided.

The inside surface of the bag 1 is designed such that an almost complete emptying of the chambers 2a, 2a′, 2a″, 2b can be realized. Both the bag 1 and the merging system 8 are made of a photoprotective plastic to protect the drugs used from light. A clear plastic can also be used.

FIG. 2 shows a second preferred exemplary embodiment of a bag 1 according to the invention for providing patient-specific oncological drugs, with a bag 1 which in its interior has four separate chambers 2a, 2a′, 2a″, 2b, wherein three of the chambers 2a, 2a′, 2a″ serve for the provision of an infusion solution and the addition of a patient-specific drug and the fourth chamber 2b for the provision of a rinse solution. The bag 1 is made of a wide and clear polymer tube, specifically made of polyolefin (POF). Around the bag 1, a photoprotective protective cover, not shown in FIG. 1, can be arranged. Both the left and right bag walls are formed by folding the tube. At the top and at the bottom, the tubular bag 1 is welded shut. The inner walls 4 of the individual chambers 2a, 2a′, 2a″, 2b are also formed by welding. The chambers 2a, 2a′, 2a″, 2b have partially different volumes. The shape of the bag 1 or the chambers 2a, 2a′, 2a″, 2b is designed such that an almost complete emptying of the chambers 2a, 2a′, 2a″, 2b can be realized. Furthermore, the chambers 2a, 2a′, 2a″, 2b are elongated and extend from the upper end to the lower end of the tubular bag 1. On their lower side, they each have—through the welds—a connecting piece 5, 6, which can serve both as a tube inlet 5 for filling the chambers 2a, 2a′, 2a″, 2b and as a tube outlet 2a, 2a′, 2a″, 2b for emptying the chambers 2a, 2a′, 2a″, 2b.

The connecting piece 5, 6 is associated with a Luer-Lock tube connector 7, by means of which the bag 1 and the individual chambers are connected to a merging system 8. Other means of connection of the merging system 8 are conceivable. The merging system 8 comprises individual tubes, which are connected at one end to a connecting piece 5, 6 of a chamber 2a, 2a′, 2a″, 2b, and are merged at the end opposite the connecting piece 5, 6 into a single tube. In the area of the Luer-Lock tube connector 7 or in the area before the merger of the individual tubes, each tube is provided with plastic closing clips 9 for regulating or opening and closing the flow. The left-most tube of the merging system 8 is assigned an injection port 10 for further injections during a treatment. At the end of the merging system 8 opposite the bag 1, an opening 11 or a port for administering the drug via an infusion line to the patient is provided. In the opening 11, a silicone plug is provided.

Frequently, the tube system 8 is pre-filled before the administration of the liquids or active substances located in the chambers 2a, 2a′, 2a″ through the opening 11 with saline, so that the patient is supplied with sufficient liquid/saline. Since the contents of the individual chambers 2a, 2a′, 2a″ are generally not allowed to mix, they are administered to the patient one after the other. For this purpose, the administration of the liquids of the individual chambers 2a, 2a′, 2a″, 2b is controlled by the closing clips 9 and between the administration of two liquids or active substances at least the last section of the merging system 8, in which the individual tubes connected with the chambers 2a, 2a′, 2a″, 2b are merged in a tube, is rinsed with rinse solution, in particular with saline.

With regard to further advantageous embodiments of the bag according to the invention, reference is made to avoid repetition to the general part of the description and to the appended claims.

Finally, it should be expressly understood that the above-described embodiments of the bag according to the invention are merely for the purpose of discussion of the claimed teaching, but this is not limited to the exemplary embodiments.

### REFERENCE SYMBOL LIST

1 Bag
2a, 2a′, 2a″ Chamber with infusion solution and active substance
2b Chamber with rinse solution
3 Weld seam
4 Walls of the chambers
5 Connecting piece, tube inlet
6 Connecting piece, tube outlet
7 Luer-Lock tube connector
8 Merging system
9 Closing clips
10 Injection port
11 Opening/port of the merging system

1. A bag for providing patient-specific, in particular oncological drugs, with an interior divided into a plurality of, preferably four, separate chambers, wherein in at least one, preferably three chambers, an infusion solution can be provided and patient-specific active substances can be added.

2. The bag according to claim 1, wherein at least one chamber serves to provide a rinsing solution.

3. The bag according to claim 2, the interior of the bag having four chambers, of which three serve to provide an infusion solution and the addition of a patient-specific active ingredient and one serves to provide a rinse solution.

4. The bag according to claim 1, the bag comprising a tube, and the chambers are formed by at least one of a group including welds, gluing, and clamping means.

5. The bag according to claim 1, the chambers being multi-layered, wherein the layers include either the same materials as one another or different materials from one another.

6. The bag according to claim 1, the chambers being at least one of equal in their volume or dimensioned differently.

7. The bag according to claim 1, each chamber is being assigned at least one connecting piece for at least one of filling or emptying the chamber.

8. The bag according to claim 1, and on the container, a merging system is mounted.

9. The bag according to claim 8, the merging system having an injection port for adding further liquids.

10. The bag according to claim 8, at least one of the merging or the administration of the solutions being regulatable via tube clamps.

11. The bag according to claim 1, at least one of a group including the bag, the connecting pieces, and the merging system being produced based on polymer, the polymer comprising polyolefins (POF) selected from a group including polyethylene (PE), polypropylene (PP), polyvinyl chloride (PVC), and ethylene-vinyl acetate (EVA).

12. The bag according to claim 1, at least one of a group including the shape, the material, the surface structuring of the chambers, the connecting pieces, and the merging system is/are designed such that an at least almost complete administration of the solutions is feasible.

13. The bag according to claim 1, at least one of a group including the chambers, the at least one connecting piece, and the merging system are made of colored plastic which has a photoprotective effect.

14. The set for providing patient-specific oncological drugs, comprising a bag according to claim 1 and a merging system coupled with the bag for administering patient-specific oncological drugs to a patient, wherein the bag and the merging system are housed one of together or individually in a closed package.

15. The bag according to claim 4, the tube comprising a polymer tube

16. The bag according to claim 15, the polymer of the polymer tube comprising one or more polyolefins (POF) of a group including polyethylene (PE), polypropylene (PP), polyvinyl chloride (PVC), and ethylene vinyl acetate (EVA).
